(19) United States
(12) Patent Application Publication
(10) Pub. No.: US 2007/0213096 A1
(43) Pub. Date: Sep. 13, 2007

(54) Subscriber Identification Card Performing Radio Transceiver Functionality for Long Range Applications

(76) Inventors: Valter Bella, Torino (IT); Claudio Borean, Torino (IT); Maurizio Crozzoli, Torino (IT); Daniele Disco, Torino (IT); Tiziana Tambosso, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/587,053

(22) PCT Filed: Apr. 21, 2004
(86) PCT No.: PCT/EP04/04191

§ 371 Date: Oct. 20, 2006

(51) Int. Cl. H04M 1/00

(52) U.S. Cl. 455/558

(57) ABSTRACT

A subscriber identification card performing radio transceiver functionality for long-range applications incorporates a radio transceiver including an antenna formed on a card surface, an RF module and a base-band module. The antenna and the transceiver operate in the microwave/millimetre waves frequency range. This allows meeting the dimensional constraints imposed by the plug-in size and attaining a long-range operation. At least the base-band module might be integrated within the same chip executing standard security related functions for the terminal.

### FIELD OF THE INVENTION

The present invention refers to subscriber identification card performing radio transceiver functionality for long-range applications, and to a mobile terminal including said card.

### BACKGROUND OF THE INVENTION

Subscriber identification cards such as SIM (Subscriber Identity Module) or USIM (UNIVERSAL SIM) cards are a kind of integrated circuit card used, among others, in mobile terminals. Similar subscriber identification cards can be used, for example, in user terminals connected to a wired network, such as a wide area network (WAN), a local area network (LAN) or a telephone line. The integrated circuit of a subscriber identification card is substantially a micro-controller, with memory areas for programs and data (in particular information characterising a user), and a processing unit entrusted with the execution of a number of security-related functions (such as user authentication and communication encryption).

At present, such subscriber identification cards are generally provided in two standard sizes: full-sized (or ISO-sized) cards have the size of a conventional credit card, whereas plug-in sized cards are much smaller and are about 25 mm long, 15 mm wide and 1 mm thick. Plug-in sized cards are generally used in the most recent mobile telephones, whose reduced sizes are incompatible with a full-sized card. Standardisation of an even smaller size (e.g. 3FF-third Form Factor-card) is in progress.

Several proposals exist for incorporating contactless functionalities into a SIM card.

US-A 2003/085288 discloses a plug-in module for contactless transactions detachably connected to an external antenna. The antenna is formed by a wire, a printed line of conductive ink or a conductive strip and is applied onto a full-sized card holding the plug-in module and carried by the mobile terminal. The antenna is a low frequency antenna, suitable only for short-range communication (typically 80 cm-1 m), and it is not integrated onto the plug-in module.

EP-A 820178 discloses a cellular telephone incorporating the electronics for implementing both a cellular telephone function and a contactless card function. The antenna for the contactless card function is an inductive antenna, which only permits short-range communication. The antenna and the contactless card are not integrated with the SIM card of the cellular telephone, even if some of the contactless card control functions can be performed by the SIM processor.

JP-A 2002-236901 discloses a plug-in sized SIM card having also the possibility of contactless interaction with the telephone, in case the usual contact interaction is not operative. To this end the card integrates an antenna, which however is suitable only for connection inside the telephone, that is over a range of a few centimetres at most. The telephone body includes a second antenna for contactless transactions managed by the SIM card, yet such an antenna is a coil-type antenna allowing only short-range operation.

AU-B 736350 discloses a SIM card, preferably of the full-size type, integrated with a coil-type antenna for RF communication with an external device. Communication with the external device requires a dedicated integrated circuit, connected with the antenna, separate from the integrated circuit devoted to the SIM functions. The coil antenna is suitable only for short-range operation,.

WO-01/80193 discloses a cellular telephone with a SIM card having also the functions of a contactless transaction card for RF communication with an external device. Even if the details of the antenna are not disclosed, the document repeatedly states that the card is intended only for short-range communication.

In summary, all prior art proposals for providing the SIM card of a mobile terminal with contactless functions, only disclose the possibility of operating at short distance from the mobile terminal. This represents an undesirable limitation in the possibility of future applications of portable devices.

It is an object of the present invention to provide a subscriber identification card with an antenna and the circuitry necessary to establish a long-range radio connection.

### SUMMARY OF THE INVENTION

According to the invention, such an object is achieved by means of a subscriber identification card equipped with radio transceiver circuitry and for long range applications. The invention is characterised in that, in order to achieve long-range operation, said radio transceiver operates in the microwave/millimetre wave frequency range (0.3 GHz-300 GHz).

Use of a radio chain operating in the microwave/millimetre wave frequency range allows operating with far lower powers and over longer distances than attainable by conventional techniques (e.g. RFID and e-tag systems) while meeting the dimensional constraints imposed by a plug-in card size.

### BRIEF DESCRIPTION OF THE DRAWINGS

Further objects, characteristics and advantages of the invention will become apparent from the following description of a preferred embodiment, given by way of non-limiting example and illustrated in the accompanying drawings, in which:

FIGS. 1A and 1B show a SIM card equipped with a radio transceiver, seen from the contact side and from the antenna side, respectively;

FIGS. 2A and 2B show a mobile telephone equipped with the SIM card according to the invention;

FIG. 3 is a general block diagram of the circuitry of the SIM card according to the invention;

FIG. 4 is a schematic cross-sectional view of the SIM card of FIG. 3;

FIGS. 5 and 6 are enlarged views of a detail of the SIM card, showing examples of the connection between the antenna and the RF module;

FIGS. 7 and 8 are functional block diagrams of two possible embodiments of the SIM card chip;

FIG. 9 is a possible layout of the antenna;

FIG. 10 is a diagram of the reflection coefficient of the antenna shown in FIG. 9;

FIGS. 11 and 12 are schematic illustrations of two exemplary situations of use of a mobile terminal equipped with the SIM card of the invention; and

FIG. 13 shows a variant embodiment of the SIM card of the invention and its arrangement within a cellular phone.

### DESCRIPTION OF THE PREFERRED EMBODIMENT

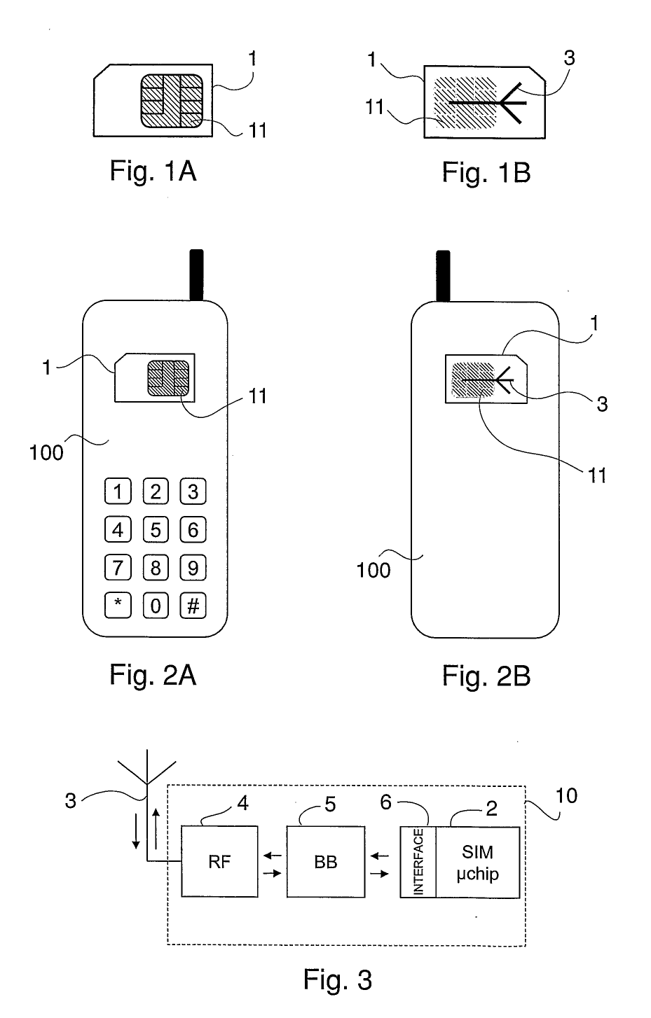

Referring to FIGS. 1A and 1B, there is provided a subscriber card, e.g. a plug-in sized SIM card 1, incorporating a microwave/millimetre wave (0.3 GHz-300 GHz) RF transceiver chain comprising an antenna 3 and the whole circuitry necessary to implement a radio transceiver for long range operation. FIGS. 1A and 1B show a single-chip card, in which the same microchip performs both radio transceiver functions and conventional functions required in a mobile communication system. The Figure shows contacts 11 of the microchip, which is not visible being embodied in card 1. The antenna is formed on the plane opposite to the plane of contacts 11, as shown in FIG. 1B and as it will be discussed in further detail below.

Card 1 has to maintain its standard size and shape notwithstanding the additional functions: thus it can be introduced in a mobile terminal, e. g. a cellular telephone 100, in place of any conventional plug-in sized SIM card, as shown in FIGS. 2A and 2B. The addition of radio transceiver functions also has to leave unchanged all conventional SIM card functions related to mobile communications (identification, security, encryption, services provided by the operator . . . ).

A general block diagram of the SIM card 1 according to the invention is shown in FIG. 3, where reference 10 denotes the whole of the electronic circuitry of the card. The conventional SIM card functions related to mobile communications are incorporated in microchip 2. As far as the wireless functions are concerned, circuitry 10 comprises an RF module or transceiver 4 coupled with antenna 3 and a module 5 for processing the base-band signals. Module 5 also contains a microprocessor with the related management and control software for the transceiver functions. Base-band module 5 is connected through a proper interface 6 to chip 2 of the SIM card. For sake of clarity, the components added for performing the transceiver functions have been shown separated from chip 2 in block 10.

The radio circuitry of the SIM card can operate either in time-division duplexing (TDD), i. e. transmission and reception use a same frequency but occur at different instants, or in frequency-division duplexing (FDD) operation, i. e. different frequencies are used for the two directions of communications. In the former case, a switch is needed, whereas in the latter case it will be sufficient to connect a duplexer to antenna 3.

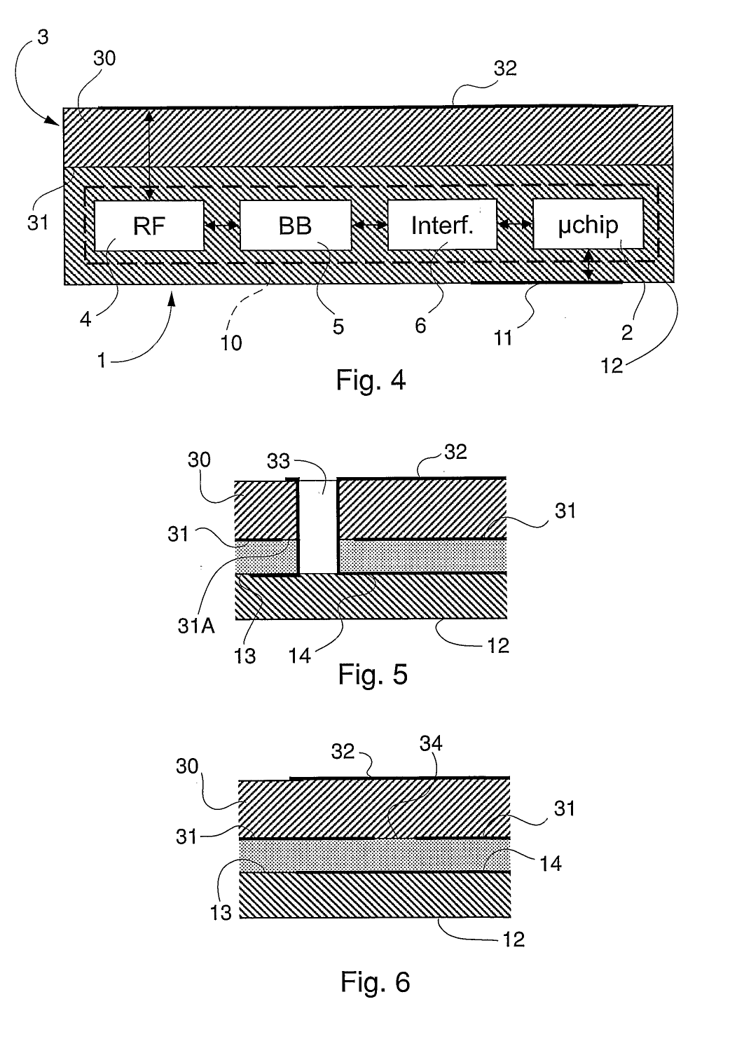

FIG. 4 is a longitudinal sectional view through card 1. The elements already disclosed in FIG. 3 are denoted by the same reference numerals. Like in FIG. 3, the additional circuit components performing the radio transceiver functions are shown as elements distinct from chip 2. As shown, such components are located in card portions not occupied by chip 2. Contacts 11 of chip 2 are formed on lower surface 12 of card 1 (contact plane), with reference to the drawing. Antenna 3 is a printed antenna, for example a patch antenna. It comprises a dielectric substrate 30, of which one surface (the bottom surface, which in the finished card is embedded in the card itself) is completely metallised and forms a ground plane 31, whereas the upper surface, which in the finished card forms the outer card surface opposite to the contact area of chip 2, bears one or more radiators 32.

Forming antenna 3 on the card surface opposite to contact plane 12 results in an optimum exploitation of the available surface in the card and takes advantage of the presence of ground plane 31 to shield the circuits in block 10 from the electromagnetic signals emitted by the same antenna 3.

With the construction shown, electrical coupling of antenna radiator 32 with transceiver 4 requires crossing ground plane 31. The techniques used for manufacturing printed circuit boards can be advantageously exploited to make said coupling. For example, as shown in FIG. 5, connection is established through a metallised hole 33 (a so-called via-hole), around which a small metallisation annulus 31A is eliminated in ground plane 31 to avoid short-circuits between hole 33 and the ground plane itself. Once the level of component plane 13 is attained, a suitable conductive line 14 connects via-hole 33 to the transceiver.

An electromagnetic coupling through an aperture 34 in ground plane 31 could be used as well, as shown in FIG. 6, for connecting antenna plane to signal processing circuitry plane (see “Microstrip Antennas” ed. D. M. Pozar and D. H. Schaubert, IEEE press NJ 1995, pp. 331, 421).

Radiofrequency module 4, base-band module 5 and interface 6 may be part of one or more additional chips, which is or are embedded within the card in the same manner as chip 2. However, as shown in FIGS. 1A and 1B, they may be integrated into chip 2 to form a single-chip card. The latter solution avoids unnecessary duplications of memories and processors and could be optimised in terms of electromagnetic compatibility.

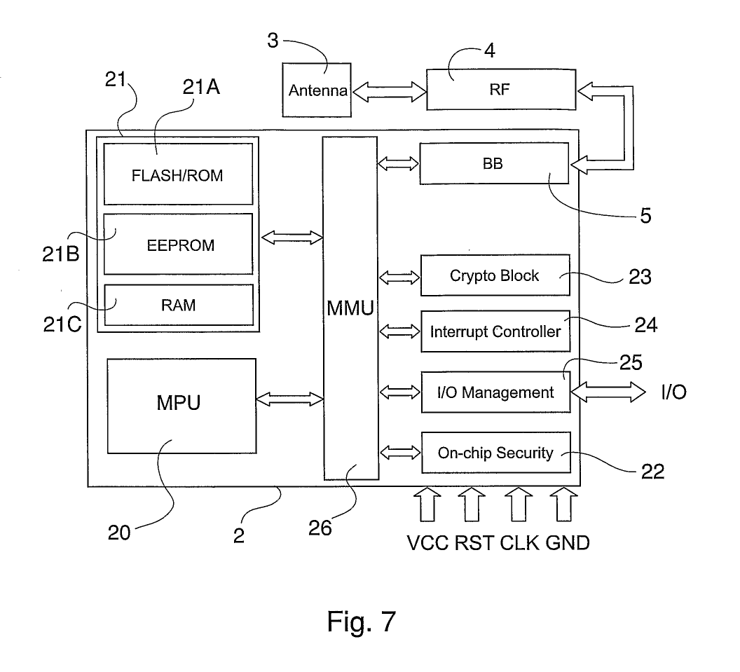

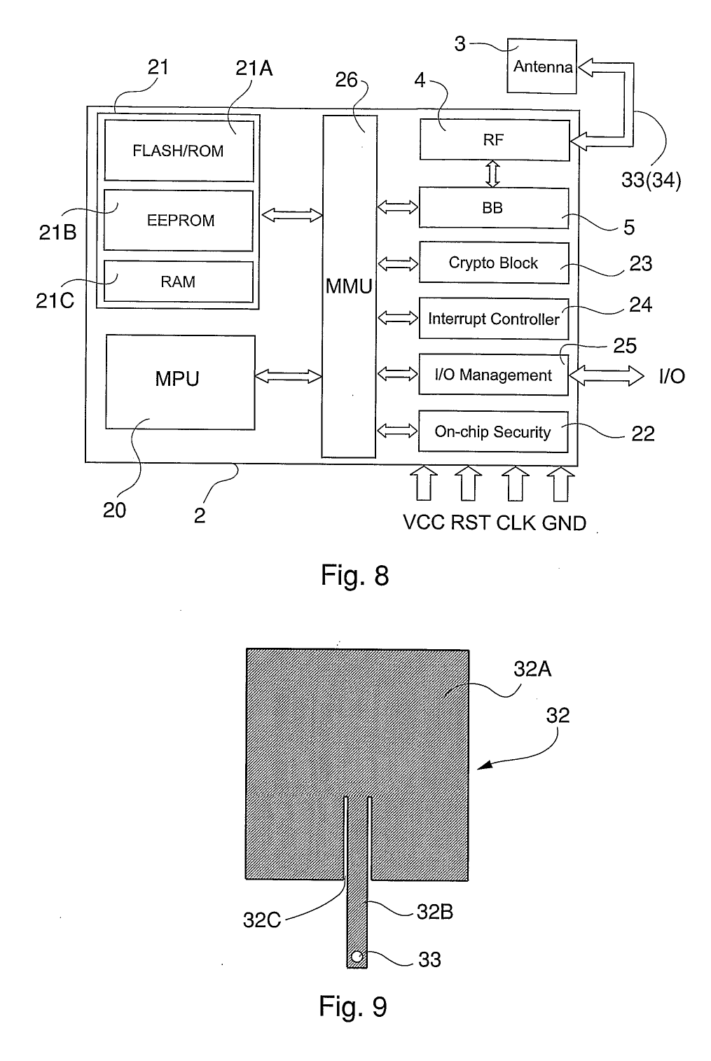

FIGS. 7 and 8 show two possible organisations of the chip of the SIM card according to an embodiment of the invention, corresponding to two different degrees of integration of the transceiver functions into chip 2 performing the conventional SIM card functions.

Microprocessor unit (MPU) 20, memory area 21 including a FLASH/ROM (program memory) 21A, an EEPROM (user memory) 21B and a RAM 21C, on-chip security module 22, block 23 performing cryptographic functions, interrupt controller 24 and I/O management module 25 are the conventional functional modules of any SIM card chip. All the above mentioned units are interconnected through a memory management unit (MMU) 26. Also indicated are the usual pins for I/O signals, the power supply (VCC), the ground voltage (GND) and the reset and the clock signals RST, CLK.

FIG. 7 assumes that transceiver module 4 is external to the SIM and is connected with base-band processing module 5 which is internal to chip 2. Base-band processing module 5 has access to microprocessor 20 and memory block 21 through memory management unit 26. In FIG. 8, also transceiver 4 is internal to chip 2 and it is connected to the antenna contacts through the via-hole 33 or the electromagnetic coupling 34 shown in FIGS. 5 and 6.

As said, partial or complete integration of the transceiver functions into chip 2 allows using microprocessor 20 and memories 21 also for such functions. Moreover, the wireless communication can take advantage of the security and information encryption functions conventionally provided by the SIM card.

However, even when base-band module 5 is external to chip 2, the microprocessor-based control and management tasks of the transceiver might be shared between such module and SIM microprocessor 20, or yet be completely implemented by the latter, instead of being wholly implemented in the same chip as module 5.

In order to attain a long-range operation while meeting the size constraints imposed by a plug-in sized SIM card, the transceiver operates in the microwave/millimetre wave frequency range (0.3 GHz-300 GHz).

In fact, let us consider the following equation linking gain G of an antenna to its equivalent area A_{eq} (substantially related to the geometrical area of the antenna):

$${A}_{eq} = \frac{{λ}^{2}}{4 π} G \qquad ( 1 )$$

where λ=c/f is the wavelength corresponding to the frequency used and c is the speed of light. Equation (1) shows that, by increasing the frequency, the same gain can be obtained with smaller geometrical size of the antenna. This is important for the aims of the invention, where severe size constraints exist and a reduced transmitted power is important.

Hereinafter, reference will be made by way of non-limiting example to a frequency of 5.8 GHz, which is the highest frequency range presently reserved to industrial, scientific and medical (ISM) applications. Moreover, we will assume a desired operating range of 20 m.

In order to determine the antenna gains and transceiver powers involved in a typical radio link between two wireless systems, the following well known transmission equation is considered:
P_{R}=P_{T}+G_{T}+G_{R}+A_{FS} (2)
where P_{R} and P_{T} are the received and transmitted powers (dB) respectively, G_{R} and G_{T} (dB) are the antenna gains at both ends of a connection with length d, and A_{FS} (dB) is the free space attenuation, given by:

$${A}_{FS} = 20 {log}_{10} ( \frac{4 π d}{λ} ) \qquad ( 3 )$$

For sake of simplicity we will assume that the transceivers at both ends of the connection are identical, i.e. are capable of emitting the same maximum power in transmission and have the same receiver sensitivity, and that the antenna gains G_{T} and G_{R}, on both sides of the link, are the same.

Let us consider a receiver sensitivity P_{R}=−65 dBm and a couple of antennas with equal gain G=3 dBi, which value is compatible with the present technologies for manufacturing patch antennas sufficiently small to be applied onto a plug-in sized SIM card. For the above mentioned frequency and operating range, A_{FS} is 73.73 dB. Under such conditions, the necessary power to be delivered by the transmitter is P_{T}=+2.73 dBm, which is achievable with state of the art integrated transceiver devices.

Notwithstanding the long operation range, the power levels concerned are quite low (e.g. 10-100 mW). Taking into account that great attention is to be paid to the aspects concerning the safety and the health of the operators working in close vicinity of frequently interrogated terminals, it is clear that the present invention is quite satisfactory also as far as safety and health aspects are concerned.

An important aspect for the system construction is the design of the antenna, which has to take into account both the geometrical constraints imposed by the plug-in sized SIM card and the operating frequency of the system, the choice of which is strictly related to the physical size of the antenna, as shown by equation (1). In case a patch antenna is used, for operation at above frequency of 5.8 MHz, an antenna element 32 with the layout shown in FIG. 9 is suitable. Element 32 comprises a square or rectangular microstrip patch 32A and a microstrip line 32B which partly extends into the area delimited by patch 32A, from which it is separated by slits 32C. Via-hole 33, if provided, opens near the free end of line 32B. The skilled in the art has no problem in determining the antenna parameters for the desired operating frequency. For instance, for operation at the above mentioned frequency of 5.8 GHz, microstrip patch 32A has an antenna-feed side of 14 mm and the other side of 14.46 mm. Microstrip line 32B has a width of 1.8 mm and extends inside patch 32A by 5.23 mm. The dielectric substrate is 0.762 mm thick and its dielectric constant is 3.26.

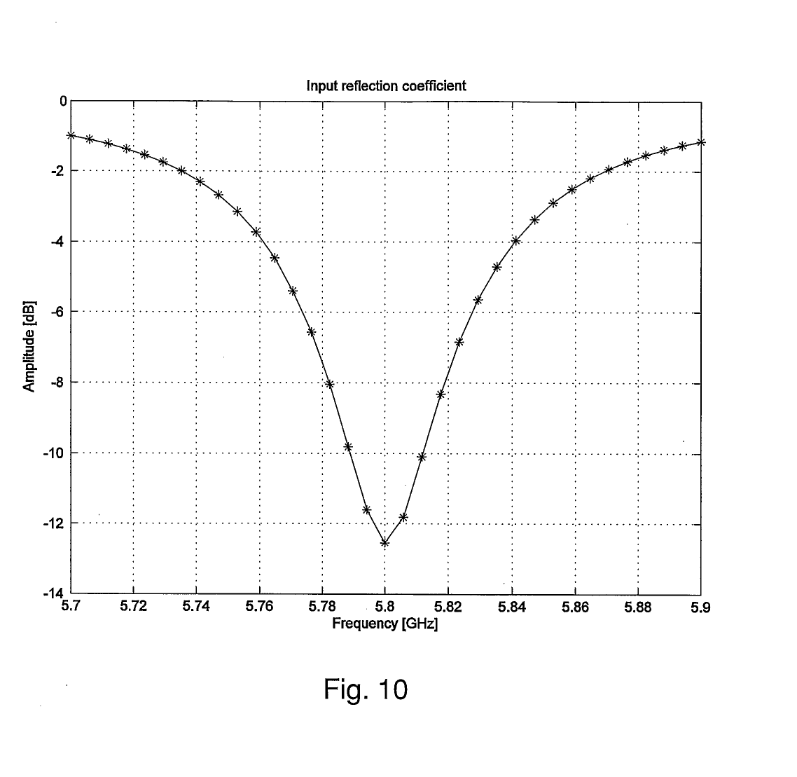

FIG. 10 shows a diagram of the absolute value of the input reflection coefficient of an antenna like that shown in FIG. 9, having the sizes mentioned above. The amplitude (in dB) is plotted in the ordinates and the frequency (in GHz) in the abscissas. The resonance centred at 5.8 GHz is clearly apparent.

An operating frequency equal to or higher then 1 GHz can be anyway preferable, mostly due to design constraints in dimensioning the antenna, as well as an upper limit of 100 GHz is preferably set in order to maintain the complexity and the cost of the transceiver under satisfactory limits.

A similar design can be carried out at relatively high frequencies, e.g. 60 GHz, resulting in a smaller size antenna. A plurality of smaller size antennas can be arranged to form a single array antenna.

If an array antenna is employed, an operating frequency equal to or higher than 10 GHz can be preferable, due to design constraints in dimensioning the single antennas forming the array. Again, an upper limit of 100 GHz in the operating frequency of the transceiver is useful for maintaining complexity and cost under preferred levels.

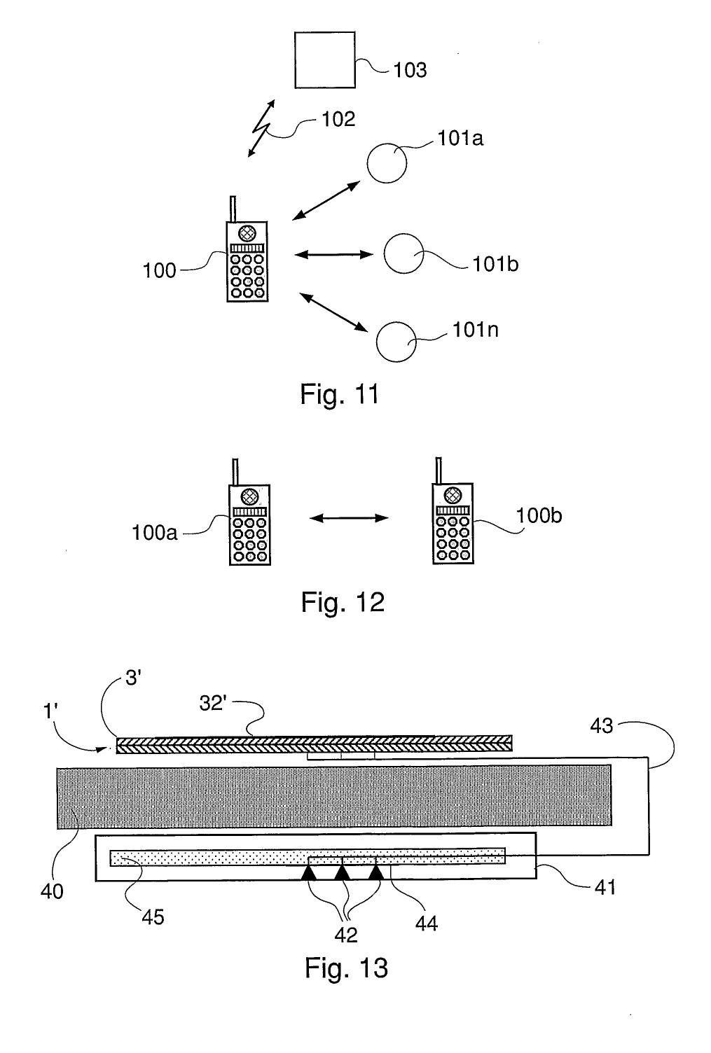

A wide range of applications can be envisaged for the disclosed system. Such applications can be based on a point-to-multipoint or a point-to-point configuration. The two possibilities are shown in FIGS. 11 and 12, respectively,

In FIG. 11, a mobile terminal 100, including a subscriber card according to the invention, communicates with a number of simpler components 101a, 101b . . . 101n such as active RFID tags (see standard for Real Time Locating Systems of INCITS T20 371.1-371.2-371.3) located at relatively long distance from terminal 100, e.g. 5 to 20 m. A configuration of that kind can be used for instance for a service in which mobile terminal 100, equipped with the SIM card according to the invention, identifies one or more of active RFID tags 101a . . . 101n through the respective code (for instance, the well known Electronic Product Code, see EPC Global standard). By accessing through the mobile communication network (e.g. GSM, GPRS, UMTS . . . ), schematised by 102, a server 103 located anywhere, the terminal uses the code to recover or supply information related to the “object” to which the RFID tag is affixed. The service may be automatically managed by the terminal or provided upon user's request.

A typical service of this kind could be the provision of tourist information and the like.

In a first example, the active RFID tags could be affixed to monuments, pictures in a gallery and so on. Terminal 100, when the monument, picture or the like is in the reach of antenna 3, reads the code of tag 101. Through the mobile communication network, terminal 100 can access remote databases storing detailed information about the monument, picture . . . and provide the user with the requested information, e.g. through the loudspeaker or the display. In this way a sort of “virtual guide” is obtained.

In another example, the active RFID tags are affixed outside restaurants, cinemas, shops. . . . This service is similar to that described above: reading the code on a tag 101 allows access to a set of specific information (the menu, the movie showings . . . ), which in part is carried by the active RFID tag and in part is accessible through the communications network 102. Updating of information on the active RFID tags could take place from a remote centre, for instance via the web.

It is to be appreciated that such applications are attractive just because the user has no need to very closely approach the monument, restaurant, shop. . . . He/she can get the information when he/she is in the most comfortable or convenient position for him/her.

Another example of application of the point-to-multipoint configuration is surveillance. The active RFID tags are affixed to the sites to be monitored, and the surveillance people are equipped with a device 100 according to the invention. Through the communication of the subscriber card realised according to the present invention with the active RFID tags, surveillance people can directly communicate checked locations to the control centre 103. The operators at the control centre can thus verify that the required schedule is observed and that no unexpected delay occurs etc. The communication can occur through the mobile network, as before. Conversely, at each check, the surveillance people could write information into active RFID tags 101 for log purposes. . . .

A further application of the point-to-multipoint configuration is in the logistics field: a device 100 according to the invention can be used to identify and track objects in a store, through the long-distance reading of active RFID tags 101 affixed to the objects. The system also allows writing the active RFID tags with the product codes when a good is entered into the store. Thus, a direct management of the store is possible. The system is attractive over the present systems based on bar codes, in that remote and contactless reading and writing of the active RFID tags is possible. Also, simultaneous reading of a plurality of active RFID tags is possible: to this end, the processing circuitry in the SIM will implement anti-collision algorithms.

In the case of point-to-point configuration, shown in FIG. 12, communication is established for instance between two mobile terminals 100a, 100b each equipped with the SIM card of the invention. Such a configuration can be used when a controlled access or a toll access exists requiring a data exchange, possibly bidirectional, between an access gate and the terminal that has to pass through the gate. Communication between the two terminals 100a, 100b can also exploit the mobile communication network (not shown).

A typical example of such application is the execution of monetary transactions, for instance for payment of a purchased object, of the parking etc. Especially in the latter case, the long-range operation is particularly attractive, in that the user does not have to search for or to very closely approach the parking meter, but he/she can perform the transaction from his/her car.

Moreover, in case of the point-to-point configuration, the invention can also represent a communication interface between two mobile terminals for long-range data exchange: such interface could represent an alternative to the infrared communication port with which many mobile terminals are equipped.

A problem that could arise when employing SIM card 1 of the invention in a cellular phone is represented by location of SIM card 1 within the phone. Indeed, a very common location for the SIM card housing, hereinafter referred to as “shuttle”, is just below the battery. Therefore the battery is almost in contact with SIM card 1 and certainly affects the radiation of SIM antenna 3. Taking into account that no constraints exist for the shapes, sizes and positions of the batteries of the cellular phones, designing antenna 3 so that its operation is scarcely affected by the battery is a difficult task.

This problem can be solved as shown in FIG. 13. Here, the elements already shown in the previous Figures are denoted by the same reference numerals with the addition of a prime. Reference numerals 40, 41 denote the battery and the SIM card shuttle of a cellular phone in which SIM card shuttle 41 is located below battery 40. According to the invention, SIM card 1′ is located above battery 40 or, more generally, in a position where the antenna operation is not affected by the battery itself. To allow the proper co-operation between the SIM chip and contacts 42 conventionally provided on the shuttle wall, the SIM chip, instead of being provided with the usual contacts 11 (FIGS. 1A, 1B), has its inputs connected to a connector 43, e.g. a set of conductors, ending at contacts 44 provided in a dummy SIM card 45 housed in shuttle 41, which contacts 44 co-operate with telephone contacts 42.

The above solution could entail some modification of certain types of commercially available cellular phones. For instance, if shuttle 41 does not allow the passage of connector 43, it should be replaced by a new one having a hole for the passage of such connector. Similarly, if the distance between the cover of the battery housing (not shown) and battery 40 is not sufficient for the insertion of SIM card 1′, the cover should be replaced by a modified one suitably shaped so as to provide room for SIM card 1′.

Moreover, SIM card 1′ with the radio transceiver functionalities can be manufactured in the most suitable size (for instance, the plug-in size) independently of the possible evolutions of the standards, which, as known, tend towards a greater and greater miniaturisation, and the size standards will have to be met by dummy SIM card 45.

The above-described invention affords important and attractive features. We may mention:
compactness and miniaturisation of the transceiver;
greater independence of the card manufactures from the mobile terminal manufacturers;
communication security;
extension of SIM functionalities (including that of e.g. RFID tag reader/writer);
possibility of application in all situations in which a long-range operation is an essential and distinctive factor.
possibility of application in all situations in which a low transmitted power, in the microwave frequency range, is a key factor in order not to generate noises and interferences to existing systems both inside the mobile telephone (e.g. Bluetooth®) and outside it (e.g. wi-fi, see IEEE802.11a, b).

It is evident that the above description has been given only by way of non-limiting example and that changes and modifications are possible without departing from the scope of the invention.

Thus, even if reference has been made in the example to an operation frequency of a few GHz, higher frequencies of some tens GHz, e.g. 10 to 100 GHz and above, could be employed. In such case it is possible to integrate onto the SIM card a patch antenna array. The manner in which this can be made is known in the art.

It is clear that the subscriber identification card object of the present invention can be used for any contactless transaction where the long-range of operation is an important requirement: this only entails a proper design of base-band circuitry 5. It should also be appreciated that the term “SIM card”, as used throughout the specification, is intended to include also the USIM (UNIVERSAL SIM) card of the UMTS user equipment as well as any smart card used in a mobile terminal and having a chip for performing communication functions for said terminal in a mobile communication system.

1-22. (canceled)

23. A subscriber identification card for a user terminal, which card is equipped with a chip for performing security-related functions for said user terminal in a communication system and with a radio transceiver comprising an antenna and circuitry performing wireless functionalities independently of the communication system, said radio transceiver operating in the microwave/millimetre wave frequency range in order to achieve long-range operation.

24. The subscriber identification card as claimed in claim 23, wherein said antenna is a printed antenna formed onto a card surface.

25. The subscriber identification card as claimed in claim 23, wherein said antenna is formed onto a card surface opposite a plane on which contacts of said chip lie.

26. The subscriber identification card as claimed in claim 25, wherein said antenna comprises at least one ground plane for shielding circuitry from electromagnetic signals emitted by the same antenna.

27. The subscriber identification card as claimed in claim 23, wherein said radio transceiver operates in a frequency band of 1 GHz to about 100 GHz.

28. The subscriber identification card as claimed in claim 27, wherein said antenna comprises a single printed radiating element.

29. The subscriber identification card as claimed in claim 28, wherein said radio transceiver operates in a frequency band centered on 5.8 GHz.

30. The subscriber identification card as claimed in claim 27, wherein said antenna comprises an array of printed radiating elements.

31. The subscriber identification card as claimed in claim 30, wherein said radio transceiver operates in a frequency band of 10 GHz to about 100 GHz.

32. The subscriber identification card as claimed in claim 31, wherein said radio transceiver operates in a frequency band centered on 60 GHz.

33. The subscriber identification card as claimed in claim 23, wherein said radio transceiver comprises an RF module connected with said antenna and a base-band signal processing circuit.

34. The subscriber identification card as claimed in claim 33, wherein said RF module and said base-band signal processing circuit are implemented on one or more integrated circuits distinct from said chip.

35. The subscriber identification card as claimed in claim 34, wherein said processing circuit has access to processing, memory and security modules in said chip and co-operates therewith for at least a part of the control and management functions and for security of the wireless communication functionalities.

36. The subscriber identification card as claimed in claim 33, wherein at least said base-band signal processing circuit is integrated onto said chip and uses processing, memory and security modules in said chip for the control and management functions and for security of the wireless communication functionalities.

37. The subscriber identification card as claimed in claim 28, wherein the or each radiating element of the antenna is connected with the integrated circuit comprising an RF module through a via-hole crossing a ground plane of a printed antenna and a conductive line on a component plane of the card.

38. The subscriber identification card as claimed in claim 28, wherein the or each radiating element of the antenna is electromagnetically coupled to a conductive line on a component plane of the card, where the integrated circuit comprising an RF module is placed, through an aperture in a ground plane of the antenna.

39. The subscriber identification card as claimed in claim 23, comprising a subscriber identity module or universal subscriber identity module card of a mobile terminal.

40. The subscriber identification card as claimed in claim 39, comprising a plug-in sized card.

41. The subscriber identification card as claimed in claim 39, comprising a third form factor card.

42. The subscriber identification card as claimed in claim 39, wherein said chip has input/output pins connected to a connector ending at a dummy card provided with contacts for co-operation with matching contacts provided in the user terminal, so that said subscriber identity module or universal subscriber identity module card is located in position where said antenna is at least partially unshielded by a power source or other electro-magnetically shielding elements of a mobile terminal.

43. A mobile communication terminal comprising the subscriber identification card integrated with a radio transceiver for execution of wireless communication functionalities as claimed in claim 23.

44. The mobile communication terminal as claimed in claim 43, wherein said subscriber identification card is the subscriber identity module or a universal subscriber identity module card of said terminal.
